(19) United States
(12) Patent Application Publication
(10) Pub. No.: US 2020/0254953 A1
(43) Pub. Date: Aug. 13, 2020

(54) MODULAR RESTRAINT SEAT FOR VEHICLE WITH ONE OR MORE INTEGRATED SAFETY FEATURES

(71) Applicant: INDIANA MILLS & MANUFACTURING, INC., Westfield, IN (US)

(72) Inventors: Chris P. Jessup, Sheridan, IN (US); Douglas W. Bittner, Indianapolis, IN (US)

(21) Appl. No.: 16/785,197

(22) Filed: Feb. 7, 2020

Related U.S. Application Data
(60) Provisional application No. 62/802,774, filed on Feb. 8, 2019.

(51) Int. Cl. B60R 21/18; B60R 21/207; B60R 21/217; B60R 22/46; B60R 21/0136; B60R 21/0132

(52) U.S. Cl. CPC B60R 21/18; B60R 21/207; B60R 21/2171; B60R 2022/006; B60R 21/0136; B60R 21/0132; B60R 22/46

(57) ABSTRACT

A modular vehicle seat is disclosed that includes one or more safety measures incorporated into the seat such that the seat can be pre-assembled in a modular unit that can be incorporated into a variety of vehicle designs. The safety measures may include an airbag deployment system that deploys an airbag from a seat back and extends around a shoulder portion of the occupant restraint system. The airbag deployment system includes an airbag that extends coaxially around the shoulder web of the restraint system of the vehicle seat. The safety measures may include a device for pre-tensioning a lap portion of an occupant restraint harness coupled to a seat portion of the vehicle seat. Illustratively, the pre-tensioning device may be activated just prior to activation of the airbag deployment system.

### CROSS REFERENCE

This application claims the benefit of priority under 35 U.S.C. § 119(e) to U.S. Provisional Patent Application No. 62/802,774, filed Feb. 8, 2019. The disclosure set forth in the referenced application is incorporated herein by reference in its entirety.

### FIELD OF THE INVENTION

The present invention relates generally to a seat having a restraint system for motor vehicles, and more specifically to a modular seat including one or more safety features, and even more particularly to a seat including: a device for pre-tensioning one or more motor vehicle seat restraint webs and/or for pulling down a motor vehicle suspension seat toward a vehicle floor; an integrated restraint inflation or airbag deployment system for deploying one or more inflatable members associated with the vehicle seat restraint webs; and/or a seat base reversion device to align the seat base with the seat back of the seat, all upon detection of an impending vehicle rollover and/or impact event.

### BACKGROUND

Motor vehicle seat restraint systems typically include a multi-point restraint harness, made up of one or more restraint webs, coupled thereto. Such motor vehicle seat restraint systems are typically incorporated into a motor vehicle seat assembly to be installed in a motor vehicle, with a portion of the restraint system and seat assembly being fixedly coupled to the motor vehicle. In certain types of motor vehicles, a vehicle seat assembly may be modular such that the seat assembly includes the restraint system secured or tethered to a body of the modular seat assembly, and the body of the modular seat assembly is thereafter secured to a portion of the motor vehicle. Such a modular design, which for example may be used in service or industrial vehicles such as an ambulance, can reduce the time and expense needed to remove and/or replace the seat assembly within the motor vehicle.

Motor vehicle seat restraint systems may further include a device or devices for pre-tensioning the restraint harness, i.e., for tightening the restraint harness about the seat occupant, under certain operating conditions such as during or in advance of a vehicle rollover and/or a vehicle impact event. In embodiments in which the motor vehicle seat is a suspension seat, i.e., a motor vehicle seat in which an occupant seat portion is suspended above a seat base by a suspension structure extending therebetween, such a device or devices may alternatively or additionally operate to pull the suspended seat portion downwardly toward the seat base under such conditions. An illustrative pre-tensioning system is disclosed in U.S. Pat. No. 9,896,006, which is hereby incorporated by reference herein.

Motor vehicle seat restraint systems may further include one or more integrated inflatable members that are associated with one or more restraint webs of the restraint system. The inflatable members are configured to be stored in an uninflated state and to be deployed to an inflated state when certain operating conditions are detected, such as during or in advance of a vehicle rollover and/or a vehicle impact event.

### SUMMARY

The present invention may comprise one or more of the features recited in the attached claims, and/or one or more of the following features and combinations thereof. In a first aspect, a modular vehicle seat assembly comprises a seat bottom and a seat back coupled to the seat bottom. The seat back includes a front surface and a back surface, the seat bottom and seat back forming a seating area for an occupant. The assembly further comprises a restraint system coupled to the back surface of the seat back and configured to include a first shoulder web that extends through an opening in the seat back and configured to extend around a portion of the occupant seated in the seat assembly adjacent the front surface. The assembly further comprises an airbag deployment system configured to change between an undeployed state to a deployed state in the event of an impact force upon the vehicle. The airbag deployment system comprises a housing unit received within the opening in the seat back and coupled to the seat back, the housings unit including a back wall, an airbag storage region, and formed to include an outlet opposite of the back wall, the back wall being substantially aligned with the back surface of the seat back and secured thereto. The airbag deployment system further comprises an airbag that coaxially surrounds the first shoulder web when the airbag is deployed, the airbag receivable within the airbag storage region of the housing unit, the airbag including a first end having a valve and an attachment strap configured to attach the airbag to the housing unit, and the airbag having a second end that is not connected to the housing unit and extends out of the outlet of the housing unit when the airbag is inflated. The assembly further includes an inflator coupled to the back surface of the seat back, the inflator including an outlet port adjacent the back wall of the housing unit and is connected to the valve of the airbag to inflate the airbag.

A second example aspect includes the subject matter of the first example aspect, and wherein the housing unit further includes a front wall that is spaced apart from the back wall and extends across the outlet of the housing unit.

A third example aspect includes the subject matter of the second example aspect, and wherein the front wall includes a web passage for a portion of the first shoulder web to extend therethrough.

A fourth example aspect includes the subject matter of the first example aspect, and wherein the restraint system further includes a second shoulder web that extends through an opening in the seat back and is configured to extend around a portion of the occupant, and wherein the airbag deployment system further includes a second housing unit received within the opening in the seat back and a second airbag that coaxially surrounds the second shoulder web.

A fifth example aspect includes the subject matter of the fourth example aspect, and wherein a second inflator is coupled to the back surface of the seat back and includes a second outlet port connected to a second valve in the second airbag to inflate the second airbag.

A sixth example aspect includes the subject matter of the fourth example aspect, and wherein the first and second housing units include first and second front walls extending across the outlets of the first and second housing units.

A seventh example aspect includes the subject matter of the first example aspect, and wherein the restraint system further comprises a lap web configured to be secured around the occupant and a retractor assembly configured to retract the lap web away from the seating area when the lap web is not in use by the occupant.

An eighth example aspect includes the subject matter of the seventh example aspect, and wherein the assembly further includes a pre-tensioning system configured to pre-tension the lap web of the restraint system upon detection of the impact force event.

A ninth example aspect includes the subject matter of the eighth example aspect, and wherein the pre-tensioning system includes a housing coupled to the back surface of the seat back, a web tensioning bar configured to retain a portion of the lap web within the housing, and an actuator that can slide the web tensioning bar within the housing from a first position to a second position.

A tenth example aspect includes the subject matter of the ninth example aspect, and wherein the lap web extends from the retractor assembly, through a web spool in the web tensioning bar, and then into the seating area, and wherein sliding of the web tensioning bar from the first position to the second position causes a portion of the lap web to be pulled from the seating area into the housing, thereby tightening the lap web around the occupant.

An eleventh example aspect includes the subject matter of the eighth example aspect, and wherein the pre-tensioning system is activated to pre-tension the lap web prior to deployment of the airbag of the airbag deployment system.

A twelfth example aspect includes the subject matter of the eleventh example aspect, and wherein the pre-tensioning device is activated less than a second before the airbag is deployed.

A thirteenth example aspect includes the subject matter of the ninth example aspect, and wherein the actuator of the pre-tensioning system is activated by a sensor system, the sensor system including a sensor configured to produce one of a roll signal and an impact signal, a processor, and a memory unit.

A fourteenth example aspect includes the subject matter of the thirteenth example aspect, and wherein the memory includes instructions stored therein which, when executed by the processor, cause the processor to process the one of the roll signal and the impact signal and to produce an activation signal if the roll signal indicates an imminent roll condition of a motor vehicle in which the vehicle seat is mounted and the impact signal indicates an imminent impact of the motor vehicle.

In a fifteenth example aspects, a restraint system for vehicle seat assembly includes a restraint harness including a first shoulder portion and a second shoulder portion, and an airbag deployment system configured to change between an undeployed state to a deployed state in the event of an impact force upon the seat assembly. The airbag deployment system comprises a first housing unit including a first back wall, a first airbag storage region, and is formed to include a first outlet opposite of the first back wall, wherein a portion of the first shoulder portion of the restraint harness extending through the first back wall. The airbag deployment system further includes a first airbag that coaxially surrounds the first shoulder portion when the first airbag is deployed, the first airbag receivable within the first airbag storage region of the first housing unit, the first airbag including a first end having a first valve, and the first airbag having a second end that is not connected to the first housing unit and extends out of the first outlet of the first housing unit when the first airbag is inflated. The airbag deployment system further includes a second housing unit including a second back wall, a second airbag storage region, and is formed to include a second outlet opposite of the second back wall, a portion of the second shoulder portion of the restraint harness extending through the second back wall. The airbag deployment system further includes a second airbag that coaxially surrounds the second shoulder portion when the second airbag is deployed, the second airbag receivable within the second airbag storage region of the second housing unit, the second airbag including a first end having a second valve, and the second airbag having a second end that extends out of the second outlet of the second housing unit when the second airbag is inflated. The airbag deployment system further includes at least one inflator including at least one outlet port connected to the first and second valves of the first and second airbags to inflate the airbags.

16 A sixteenth example aspect includes the subject matter of the fifteenth example aspect, and wherein the first and second airbags are inflated at the same time after occurrence of an impact force.

17. In a seventeenth example aspect, a restraint system for vehicle seat assembly comprises a restraint harness including a lap web portion, a retractor assembly configured to retract the lap web portion within a retractor housing, and a sensor system configured to detect an impending or occurring impact or rollover event for the vehicle. The restraint system further includes a pre-tensioning system engageable with the lap web portion, the pre-tensioning system including a housing, and a web tensioning bar slidable within the housing and an actuator. The actuator is in communication with the sensor system and is configured to move the web tensioning bar from a first position to a second position within the housing when the sensor system indicates detection of an impact or rollover event. The lap web portion is configured to extend from the retractor assembly, through the housing of the pre-tensioning system, and then into a seating area of the vehicle seat assembly.

18. An eighteenth example aspect includes the subject matter of the seventeenth example aspect, and wherein the web tensioning bar includes a web spool that the lap web portion extends around, the web tensioning bar configured to slide within a passageway of the housing from a first side of the housing to a second side of the housing.

19. A nineteenth example aspect includes the subject matter of the eighteenth example aspect, and wherein the web tensioning bar slides within a pair of slots extending within the first and second sides of the housing.

20. A twentieth example aspect includes the subject matter of the eighteenth example aspect, and wherein the web tensioning bar includes a connector arm coupled to the actuator, the connector arm coupled to the web spool to move the web spool upon movement of the actuator.

### BRIEF DESCRIPTION OF THE DRAWINGS

This disclosure is illustrated by way of example and not by way of limitation in the accompanying Figures. Where considered appropriate, reference labels have been repeated among the Figures to indicate corresponding or analogous elements.

FIG. 1A is a front perspective view of a modular seat assembly including a restraint harness system of the present disclosure, the seat assembly including a web restraint system, a seat back and a seat bottom, and further including a restraint web pre-tensioning system and an airbag deployment system in an un-deployed state.

FIG. 1B is a front perspective view of the modular seat assembly of FIG. 1A illustrating seat assembly after the airbag deployment system has been moved to a deployed state surrounding a portion of the web restraint.

FIG. 2 is rear perspective view of the modular seat assembly of FIG. 1A, illustrating a portion of the restraint web pre-tensioning system and the airbag deployment system, and further illustrating the restraint web pre-tensioning system includes two tensioning assemblies that extend along a back surface of the seat back and portion of the web restraint extends through a portion of the airbag deployment system.

FIG. 3 is a side perspective view of the modular seat assembly of FIG. 1B, illustrating the restraint harness system is connected to the seat back and extends to the seat bottom, and further illustrating the airbag deployment system includes an inflatable airbag that extends around a portion of the web of the restraint harness system and maintains the web in a spaced apart position from the seat back when the airbag deployment system is in the deployed state.

FIG. 4 is a front view of the modular seat assembly of FIG. 1B, illustrating the seat back and seat bottom have been removed to expose the pre-tensioning system and airbag deployment system further.

FIG. 5A is a front perspective view of the modular seat assembly of FIG. 1A further illustrating how a person may be seated in the modular seat assembly.

FIG. 5B, is a similar view as FIG. 5A, but illustrating the airbag deployment system in the deployed state as illustrated in FIG. 1B and further illustrating the web of the restraint harness system has been pre-tensioned as a result of the pre-tensioning system.

FIG. 6A is a perspective view of a tensioning assembly of the pre-tensioning system of the modular seat assembly of FIG. 2, illustrating the tensioning assembly is in a un-deployed or pre-deployment state, and further illustrating the tensioning assembly includes an assembly housing, a web receiver that guides the restraint webbing into the housing, and a web glide in a first state, the web guide configured to slide within the assembly housing to lengthen or shorten the amount of web within the housing.

FIG. 6B is a perspective view of the tensioning assembly of FIG. 6A, illustrating the tensioning assembly in a post-deployed state and showing the web glide has slide within the housing to a second state thereby pulling additional retainer web within the assembly housing.

FIG. 7A is a cross sectional view of the tensioning assembly of FIG. 6A, illustrating a track within the assembly housing along which the web glide slides when moving from the first state to the second state, and illustrating web of the restraint that extends up to a lap belt of the web restraint and is outside of the assembly housing is a first length.

FIG. 7B is a cross-sectional view of the tensioning assembly of FIG. 6B, illustrating the web glide has slid to the second state and pulled additional web into the assembly housing, thereby causing the length of the web restraint outside of the assembly housing to be a second length shorter than the first length in order to tighten or tension the lap belt of the web restraint against a portion of the person wearing the web restraint in the modular seat assembly.

FIG. 8A is a detailed view of the web receiver and web guide of FIG. 7A.

FIG. 8B is a detailed view of the web receiver and web guide of FIG. 7B.

FIG. 9 is a rear view of the web-pretensioning system and airbag deployment system of FIG. 2 with the restraint system removed.

FIG. 10 is a rear perspective view of the assembly housing and web glide of the tensioning assembly of FIG. 6A.

FIG. 11 is a rear view of the components of FIG. 10 illustrating the web glide is positioned to be received within the assembly housing to slide along an axis of the assembly housing.

FIG. 12 is a cross-sectional view of the components of FIG. 11 taken along the line AA.

FIG. 13 is a side perspective view of an inflator of the airbag deployment system of FIGS. 1-4, illustrating the inflator comprises an outlet port configured to be coupled to an inflatable airbag to deploy the airbag.

FIG. 14 is diagrammatic view of an inflatable airbag of the airbag deployment system of FIGS. 1-4.

FIG. 15 is a front perspective view of a front wall of an airbag housing unit of the airbag deployment system of FIG. 1A.

FIG. 16 is a front perspective view of a back wall of the airbag housing unit of the airbag deployment system of FIG. 1A.

FIG. 17 is a rear perspective view of a portion of an alternative modular seat assembly, illustrating the seat assembly includes only an airbag deployment system and does not include a tensioning system.

FIG. 18 is an exploded view of the modular seat assembly of FIG. 17.

### DETAILED DESCRIPTION OF THE DRAWING

While the concepts of the present disclosure are susceptible to various modifications and alternative forms, specific exemplary embodiments thereof have been shown by way of example in the drawing and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases may or may not necessarily refer to the same embodiment. Further, when a particular feature, structure or characteristic is described in connection with an embodiment, it is submitted that it is within the knowledge of one skilled in the art to effect such feature, structure or characteristic in connection with other embodiments whether or not explicitly described. Further still, it is contemplated that any single feature, structure or characteristic disclosed herein may be combined with any one or more other disclosed feature, structure or characteristic, whether or not explicitly described, and that no limitations on the types and/or number of such combinations should therefore be inferred.

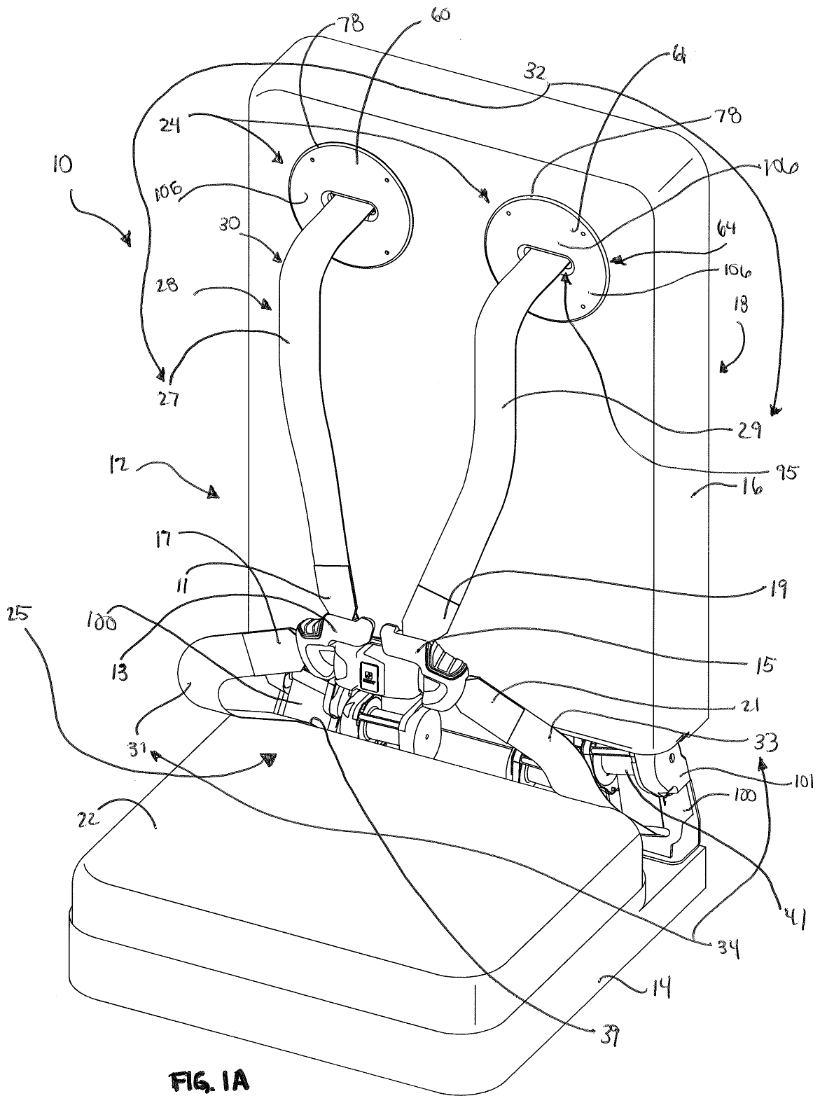

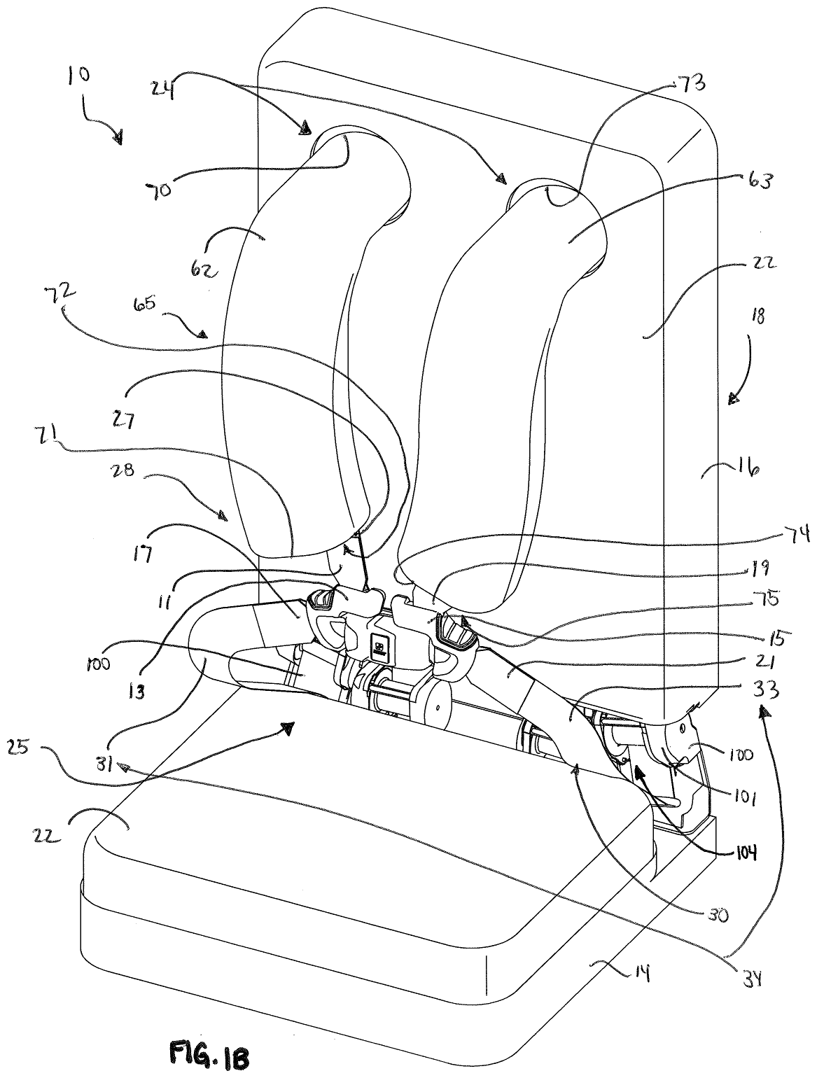

Referring now to FIG. 1, an embodiment is shown of a modular motor vehicle seat assembly 10 including an occupant seat 12, mounted to the floor or other support surface of a motor vehicle, to which a restraint system 28 is mounted. In certain applications, the seat assembly 10 further includes an embodiment of an airbag deployment system 24 coupled to a portion of the occupant seat 12. In even further certain embodiments, the seat assembly 10 further includes an embodiment of a restraint web pre-tensioning and/or suspension seat pull-down system 40 which may be desirable or necessary to deploy just prior to engagement of the airbag deployment system 24 in order to secure the occupant to the seat in a tensioned manner before airbags are deployed to engage with the occupant.

Both the airbag deployment system 24 and the pre-tensioning system 40 may be illustratively part of a vehicle rollover and/or impact detection and safety system. Specifically, both the airbag deployment system 24 and the pre-tensioning system 40 may be are configured to engage or interact with a portion of the restraint system 28. The pre-tensioning system 40 is operable to pre-tension a restraint web 30 of the restraint system 28 upon detection of an impending vehicle impact and/or rollover event. The airbag deployment system 24 is operable to cause airbags, such as coaxial airbags aligned along a portion of the restraint web 30, to deploy to absorb impact or momentum of a person restrained by the restraint system 28 upon detection of an impending or occurring vehicle impact and/or rollover event. The order of deployment for the systems 40 and 24 may be preconfigured to minimize or reduce the negative impact of the resulting event on the occupant. In one embodiment, the pre-tensioning system 40 may be deployed a few milliseconds before deployment of the airbag system 24. In other embodiments, it may be employed a second or two before deployment of the airbag system 24.

In various embodiments, the seat may be compatible with or incorporated into a suspension or pull down seat assembly for a vehicle. An illustrative example of such a seat is disclosed in U.S. Pat. No. 9,896,006, which is hereby incorporated by reference. In embodiments in which the motor vehicle seat 12 is a suspension seat, the pre-tensioning system 40 is alternatively or additionally operable, upon detection of an impending vehicle impact and/or rollover event, to pull the suspension seat down to or adjacent to a seat base of the suspension seat and/or to or adjacent to the floor of the motor vehicle in which the seat 12 is mounted.

An exemplary embodiment of the modular motor vehicle seat assembly with the safety features, such as the airbag deployment system and pre-tensioning system, is described and shown in a presentation in Appendix A. As shown, the modular design incorporates the airbag deployment system and pre-tensioning system into a single seat unit that can be installed quickly into a vehicle frame or seat assembly of various designs, for example, through use of attachment means such as a D-ring or a set of bolts. The modular design can be pre-assembled/pre-manufactured and supplied in units that can be incorporated into various vehicle types, such as an ambulance, or components of such vehicles.

Page 8 of Appendix A also illustrates another safety measure that may be incorporated into the modular design. For some purposes, a seat bottom of the proposed modular design may illustratively be moveable from a position adjacent to the seat back to a position away from the seat back in order to perform duties, such as taking care of a patient in the ambulance. Accordingly, an additional safety measure may be that the seat bottom is automatically pulled back to its original position next to the seat back before the pre-tensioning and/or airbag deployment occurs, thereby securing the occupant in a good position against the seat back in order to deploy the additional safety measures before or during an impact event.

The motor vehicle in which the motor vehicle seat assembly 10 is mounted may be any conventional motor vehicle, examples of which include, but are not limited to, an emergency vehicle, such as a fire fighting or rescue vehicle, medical vehicle, security vehicle or the like, a light, medium or heavy-duty truck, an industrial vehicle, e.g., construction and/or mining equipment, farm equipment, excavation equipment and/or other heavy equipment, a lift truck, a recreational vehicle such as an all-terrain vehicle (ATV), dune buggy or other off-road vehicle, an automobile, an electric vehicle, a utility vehicle, a commercial vehicle, a racing vehicle, and the like. In illustrative embodiments, the motor vehicle seat assembly 10 is modular in nature such that it is preassembled with the components described herein and can be installed into a vehicle via fastening, screwing and/or bolting the seat assembly 10 to a portion of the frame of the vehicle, or to a seat base assembly in a vehicle, without substantially additional assembly requirements.

As discussed, in one illustrative embodiment, the vehicle seat 12 may be considered in the form of a conventional suspension seat having a seat base (not shown) mounted to the floor of a motor vehicle, a seat frame 18 and a suspension mechanism (not shown) extending between and attached to the seat base and the seat frame 18. The suspension mechanism may be or include any conventional suspension mechanism configured and operable to suspend the seat frame 18 above seat base, examples of which include, but should not be limited to, air suspension mechanisms, mechanical suspension systems, pneumatic or hydraulic suspension systems, and the like to permit the seat frame 18 to move independently of the frame of the motor vehicle. Alternatively, the vehicle seat 12 may not be considered a suspension seat, and may instead be secured or otherwise fixed to a portion of the frame of the vehicle, such as a side wall or floor of the frame, so that movement of the vehicle seat 12 depends on movement of the vehicle frame.

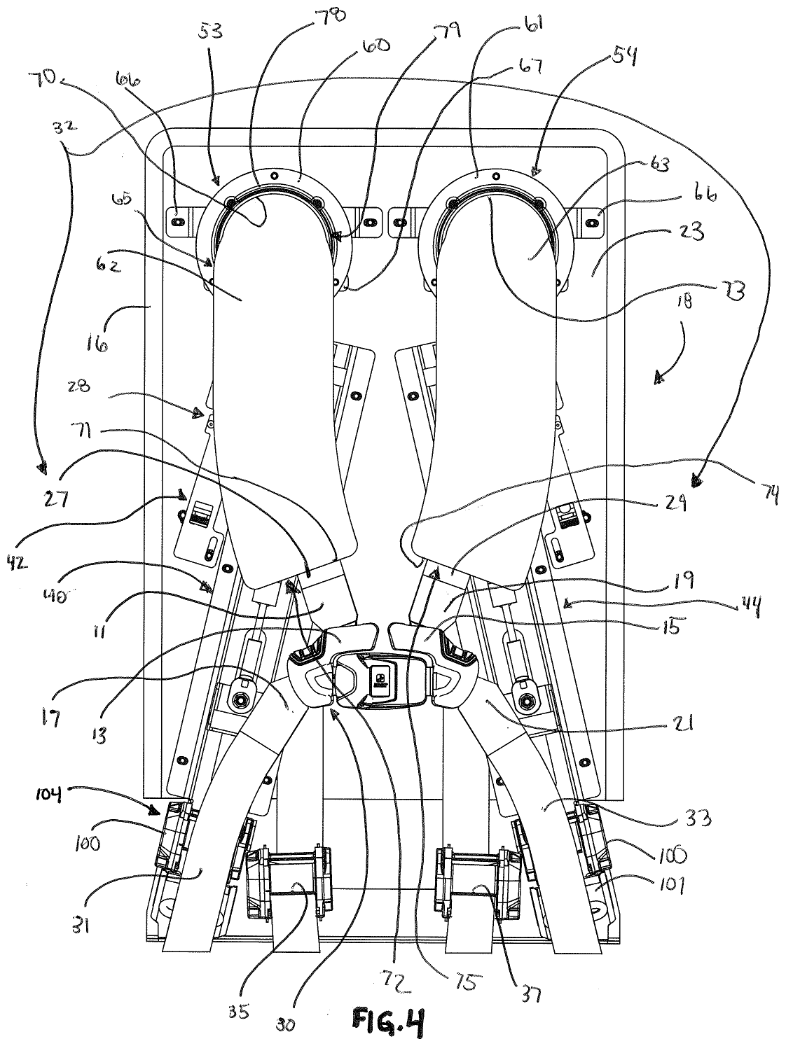

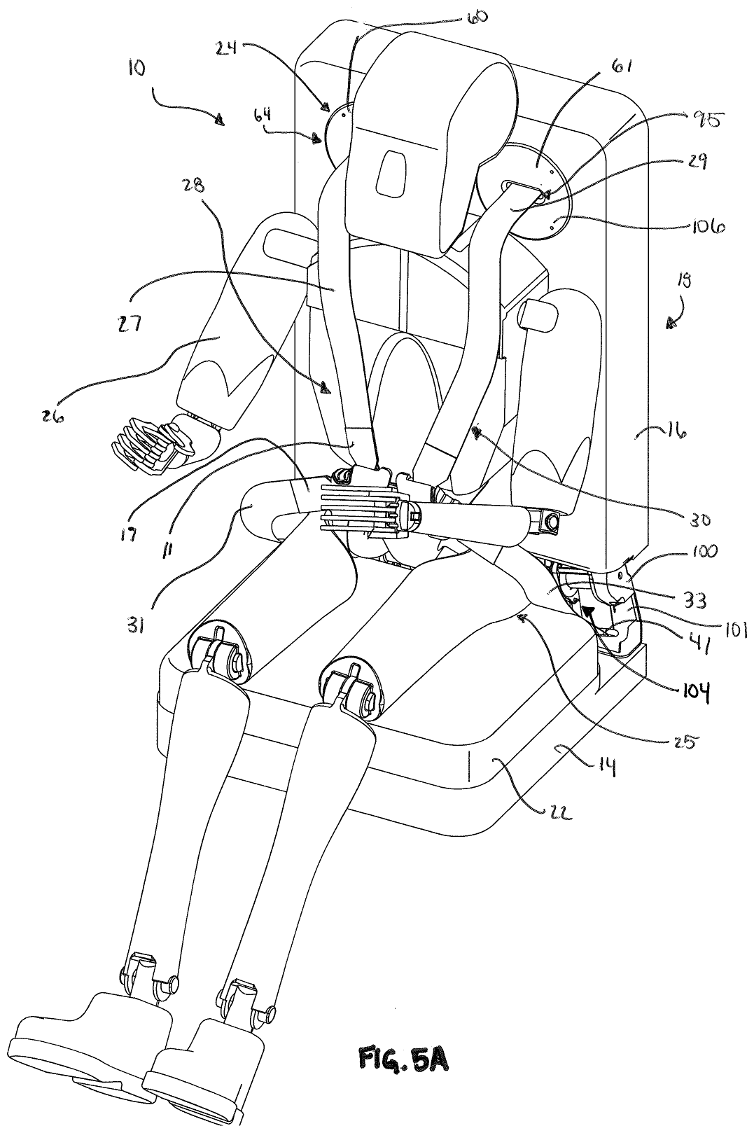

In any case, the seat frame 18 includes a seat bottom 14 and a seat back 16 extending upward and away from a rear end of the seat bottom, as illustrated in FIG. 1. The seat frame 18 may further include one or more seat cushions 22 mounted to the seat bottom 14 and the seat back 16. In an illustrated embodiment as shown in FIG. 5A, the seat frame 18 and the seat cushion 22 mounted thereto together define a seat portion 25 of the vehicle seat 12, and an occupant 26 is shown seated in, and supported by, the seat portion 25 of the vehicle seat 12. The seat back 16 includes a back surface 20 and an opposite front surface 23, the front surface 23 positioned to be adjacent the seat cushion 22.

As mentioned, the modular motor vehicle seat assembly 10 further includes a restraint system 28 including a multi-point occupant restraint harness 30. In the illustrated embodiments, the occupant restraint harness 30 is provided in the form of a four-point restraint harness defined by a first shoulder web 27, a second shoulder web 29, a first lap web 31, and a second lap web 33. The first and second shoulder webs 27 and 29 are configured to act as a torso-engaging portion 32 of the restraint harness 30, and the first and second lap webs 31 and 33 are configured to act as a lap-engaging portion 34 of the restraint harness 30.

In various embodiments, the first shoulder web 27 includes a first end 11 and a second end 35, the second shoulder web 29 includes a first end 19 and a second end 37, the first lap web 31 includes a first end 17 and a second end 39, and the second lap web 33 includes a first end 21 and a second end 41. The first end 11 of the first shoulder web 27 may be fixedly secured to the first end 17 of the first lap web 31, and the first end 19 of the second shoulder web 29 may be fixedly secured to the first end 21 of the second lap web 33, thereby forming first and second sides (e.g. left and right sides) of the restraint harness 30. Specifically, the first lap web 31 and first shoulder web 27 may be secured to a female buckle member 13 and the second lap web 33 and second shoulder web 29 may be secured to a male buckle member 15. The female buckle member 13 is configured to receive a buckle or tongue member (not shown) of the male buckle member 15 in order to releasably lock the female and male buckle members 13 and 15 together to secure the restraint harness 30 around an occupant in the seat portion 25. Other means of securing the female buckle member 13 to the male buckle member 15 are envisioned within the scope of this disclosure.

The first and second shoulder webs 27 and 29 are configured to be secured to a portion of the modular motor vehicle seat assembly 10 such as the seat frame 18. In various embodiments, the second end 35 of the first should web 27 may be configured to engage with a retractor assembly 50 that is coupled to the seat frame 18, and the second end 37 of the second shoulder web 29 may be configured to engage with a retractor assembly 52 also coupled to the seat frame 18. The retractor assemblies 50 and 52 may be configured similar to known retractor assemblies in the industry that are configured to retract the webs 27 and 29 to a tensioned or specific-length state to retrain the web securing around an occupant. For instance, the web 27 may be received around a spool (not shown) mounted in a retractor frame 51 of the retractor assembly 50, the spool being spring biased and rotatably mounted to rotate within the frame 51 to permit winding or unwinding of the web 27 around the spool to lengthen or decrease the length of the web 27. In various embodiments, the webs 27 and 29 are configured to extend through openings 53 and 54, respectively, in the seat back 16 to extend to a back side of the seat frame 18 to be secured to the retractor assemblies 50 and 52 along the back of the seat frame 18. Accordingly, decreasing the length and/or tensioning the webs 27 and 29 by the retractor assemblies 50 and 52 causes a person contained between the webs 27 and 29 and the seat back 16 to be more securely held in place in the event of an impact or crash event.

In illustrative embodiments, the airbag deployment system 24 of the modular seat assembly 10 is configured to engage with and/or extend around a portion of the first and second shoulder webs 27 and 29. The airbag deployment system 24 may be specifically configured to deploy one or more airbags that are co-axial and may be generally aligned along the webs 27 and 29 that extend along an occupants first and second shoulders in order to at least partially cushion or reduce movement of a user's head and/or shoulder during an impact force upon the occupant during a crash event.

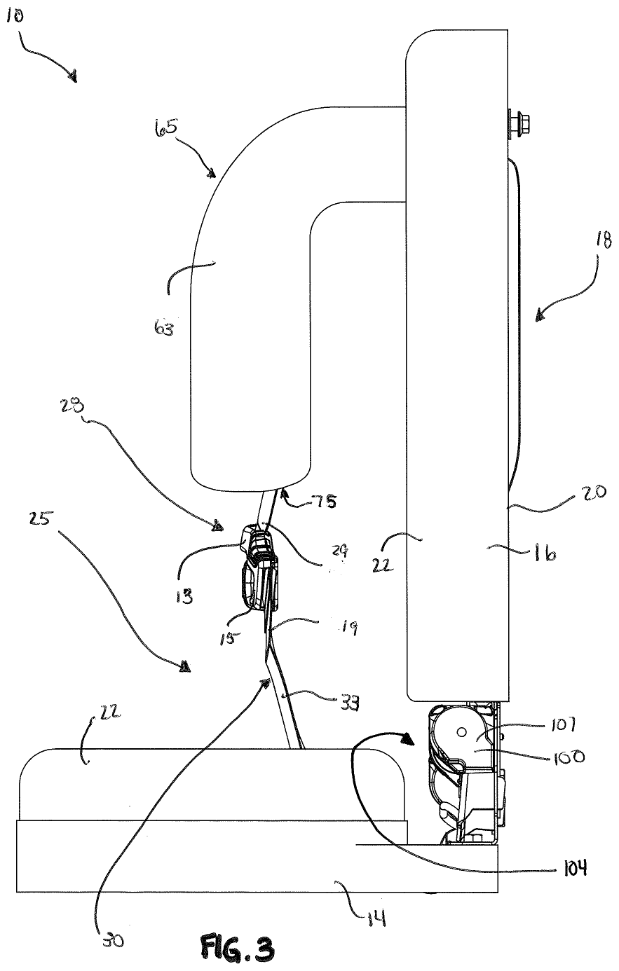

As illustrated generally in FIGS. 1B-5B and FIGS. 17-18, an illustrative airbag deployment system 24 comprises first and second airbag housing units 60 and 61, first and second inflatable airbags 62 and 63 configured to be fully or substantially housed within the housing units 60 and 61 when the airbags 62 and 63 are in an undeployed or collapsed state, and one or more inflation devices 56 configured to inflate the airbags 62 and 63 when a predetermined condition, such as an impact force or other crash activity, is detected by a sensor in the vehicle. The airbags 62 and 63 are configured to provide the occupant with a soft cushioning and additional restraint during a crash or rollover event in order to reduce injuries of the occupant as the occupant is moved within the vehicle. In an illustrative embodiment and as shown in FIGS. 3, 4 and 5B, the airbags 62 and 63 are configured to be deployed from the airbag housing units 60 and 61 within the seat back 16, above the shoulders of the occupant seated in the seat assembly 10, and along the front or torso portion of the occupant to provide the occupant during such impact events.

The airbags 62 and 63 are generally moveable from a first, undeployed state 64, as illustrated in FIG. 1A, to a second deployed state 65 where the airbags are partially or substantially filled with air provided from the inflation devices, as illustrated in FIG. 1B. As suggested in FIG. 3, the first air bag 62 may be tubular in nature with a first end 70 secured to the housing unit 60, a second free end 71 that is movable into and out of the housing unit 60, and formed to include a web aperture 72 extending from the first end 70 to the second end 71 that is sized and shaped to permit passage of the first shoulder web 27 therethrough. The first air bag 62 may be configured to extend circumferentially around the first shoulder web 27 such that a portion of the first air bag 62 is positioned between the shoulder web 27 and the occupant of the seat assembly 10. Similarly, the second air bag 63 may be tubular in nature with a first end 73 secured to the housing unit 61, a second free end 74 that is movable into and out of the housing unit 61, and formed to include a web aperture 75 extending from the first end 73 to the second end 74 that is sized and shaped to permit passage of the second shoulder web 29 therethrough. The second air bag 63 may be configured to extend circumferentially around the second shoulder web 29 such that a portion of the second air bag 63 is positioned between the shoulder web 29 and the occupant of the seat assembly 10. Accordingly, when the airbags are moved to the deployed state 65, a cushion of air is provided between the webs 27 and 29 and the occupant's torso region to reduce the impact on the occupant from the webs 27 and 29.

It is contemplated that the airbags 62 and 63 may be formed of various designs or configurations in accordance with the aspects of the present disclosure. One illustrative example of air bag 62 is shown in FIG. 14. The first end 70 of the air bag 62 is configured with one or more attachment straps 76 configured to attach the air bag 62 to the housing unit 60. The first end 70 is further formed with an air valve or other similar valve member 49, which may be a one-way valve member or a delayed two-way valve member for slow evacuation of air that provides means for inserting air into the air bag 62 to inflate the air bag 62 to the deployed state 65. Formation of another illustrative example of an air bag 62 is shown and described in Appendix B. Other means of forming or constructing the airbags 62 and 63 are envisioned herein.

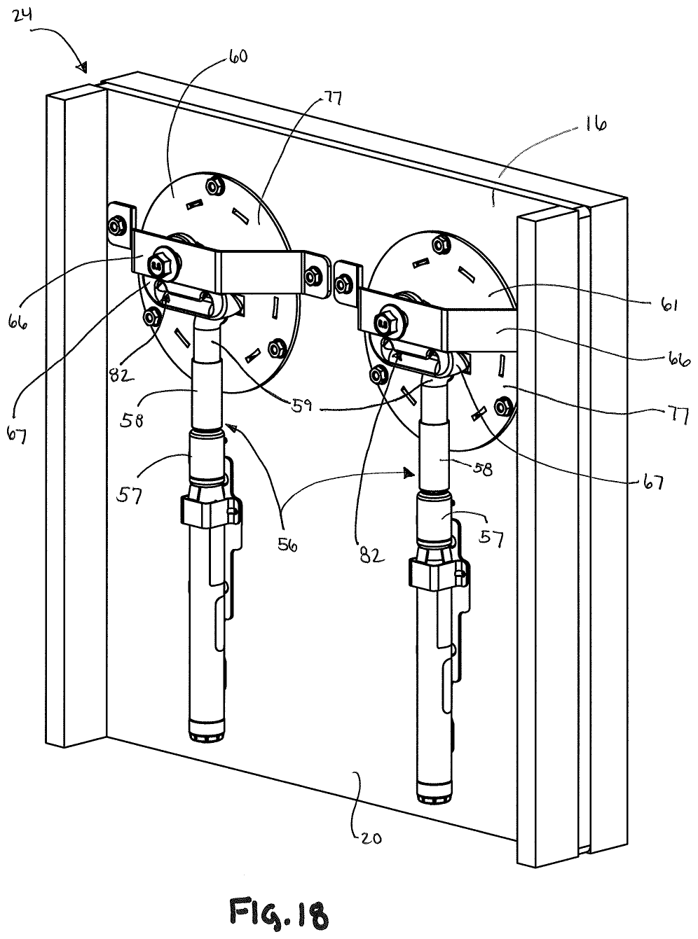

In illustrative embodiments, the airbag housing units 60 and 61 are configured to be coupled to the seat back 16 of the modular seat assembly 10 to be generally contained with the seat assembly 10, as suggested in FIGS. 17-18. In various embodiments, the housing unit 60 and 61 may be received within the openings 53 and 54 in the seat back 16. Illustratively, the housing unit 60 includes a back wall 77, an outer periphery housing wall 78 that extends from the back wall 77 and forms an air bag storage region 79 to store the air bag 62, and an attachment means, such as a bracket 66. The bracket 66 may be fixed to the back wall 77 and be attachable to the back surface 20 of the seat back 16 in order to secure the housing unit 60 within the opening 53. A bag outlet 80 is formed in the housing unit 60 generally opposite the back wall 77 and opens into the air bag storage region 79. The bag outlet 80 permits the air bag 62 to extend out of the housing unit 60 when moving to the deployed state 65. In various embodiments, the outlet 80 may be generally aligned with the front surface 23 of the seat back 16, or aligned with a surface of the seat cushion 22, in order to permit the air bag 62 to extend out and away from the seat back 16 when deployed. The airbag housing unit 61 is configured to be similar to the housing unit 60 as described herein.

In an alternative embodiment, a front wall 106 is provided with the housing unit 60 in a spaced apart manner from the back wall 77, the front wall enclosing the bag outlet 80 by coupling to the housing wall 78 to prevent undesired access to the air bag 62 when not in use. When deployment occurs, the front wall 106 may be forced out of engagement with the housing wall 78, thereby permitting the air bag 62 to be deployed into the seating area 25. The front wall 106 may include a web passage 95 formed therein to permit extension of the web 27 to extend through the front wall 106 from the web aperture 72 of the airbag 62.

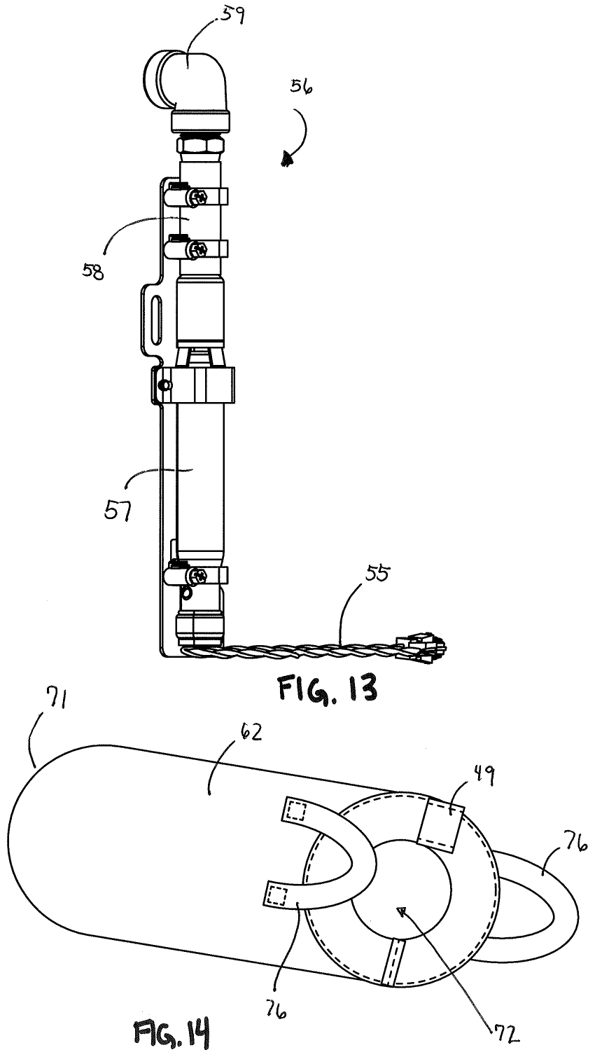

The airbag housing units 60 and 61 are configured to be coupled to one or more inflator systems 56 configured to inflate or deflate the air bags 62 and 63 with air to move them from the deflated state 64 to the deployed or inflated state 65. An illustrative embodiment of an inflator system 56 for the air bag 62 is shown in FIG. 13. The inflator system 56 is configured to be electronically connected to a conventional processor and/or conventional rollover or impact sensor (not shown) in order to be activated, as suggested by electronic connection wire 55. The sensor (not shown) may be any conventionally known sensor that can detect attributes of an impending impact, such as the angle of the motor vehicle, the angular velocity of the vehicle, the acceleration, velocity and/or inertia of the vehicle, or the like. The sensor system may also be a combination of one or more front or side sensors that senses impacts to the front or side of the vehicle seat. Those skilled in the art will recognize other types of sensors that may be incorporated herein.

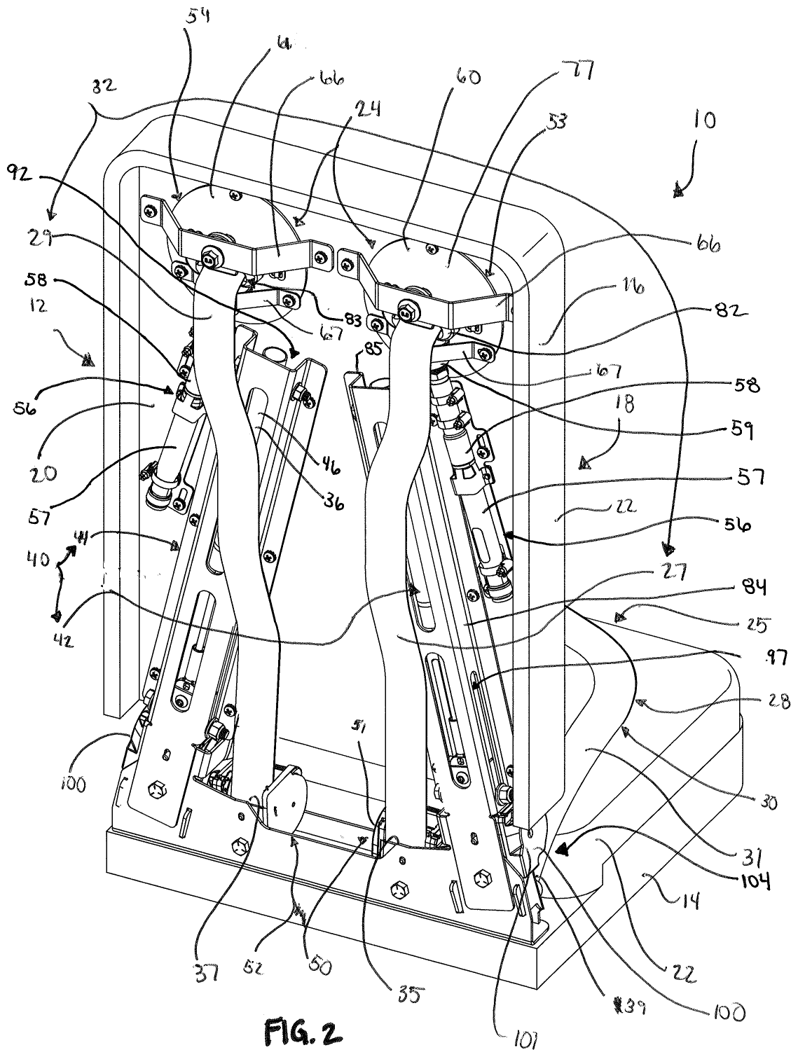

The inflator system 56 illustratively includes a housing 57, an air release mechanism such as a compressed air canister 58 electronically activated by the sensor system via the connection wire 55, and an outlet port 59 configured to be connected to the valve 49 of the air bag 62 for expelling air into the air bag 62. The housing 57 is mounted to a support surface that is rigidly coupled to the motor vehicle, such as the back surface 20 of the seat back 16. Those skilled in the art will recognize other viable support structures in the vehicle for such mounting. The outlet port 59 is illustratively coupled to the back wall 77 adjacent an air passageway 45 that extends through the back wall 77 of the housing unit 60, which is illustrated in FIG. 15. The air passageway 45 is configured to permit the outlet port 59 to be fluidly connected to the air bag 62 within the housing unit 60. In various embodiments, the outlet port 59 is secured to the back wall 77 around the air passageway 45 via one or more brackets 67 that extend around the outlet port 59 and are secured to the back wall 77 at connection points 68, as illustrated in FIG. 2. Alternatively, the brackets 67 may be secured between the brackets 66 and the outlet port 59 to retain the outlet port 59 against the back wall 77, as illustrated in FIGS. 17-18. As illustratively shown, a compressed air canister of the inflator system 56 is configured to release air through the outlet port 59 when activated in order to inflate/deploy the air bag 62 when the sensor indicates a crash or impact event is imminent or occurring.

It is envisioned that the inflator system 56 may be of other various alternatives forms. For example, while two inflator systems 56, are illustrated in the Figures, a single a system 56 may be used to inflate both the first and second airbag housing units 60 and 61 through a check valve or other similar mechanism coupled to the back 20 of the seat that can inflate multiple air bags. Other forms of inflating the airbags are envisioned herein.

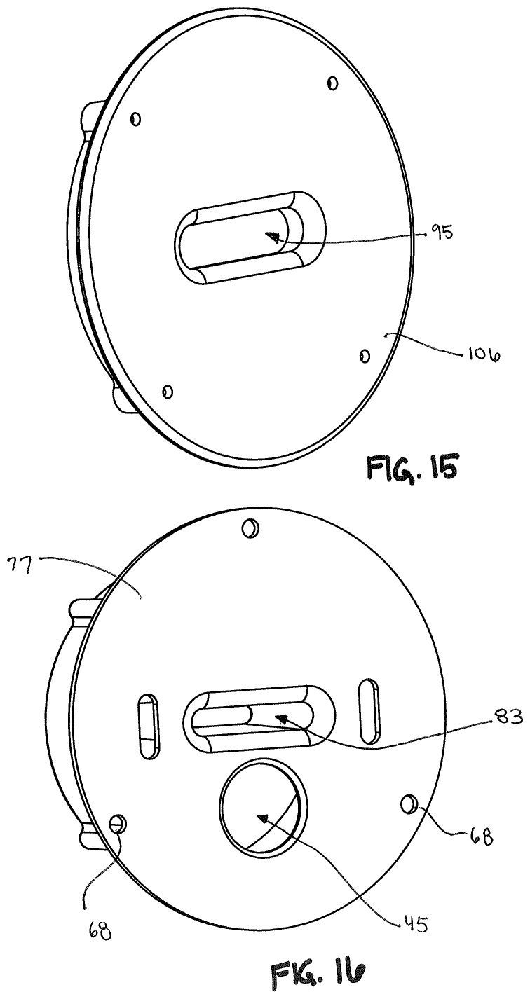

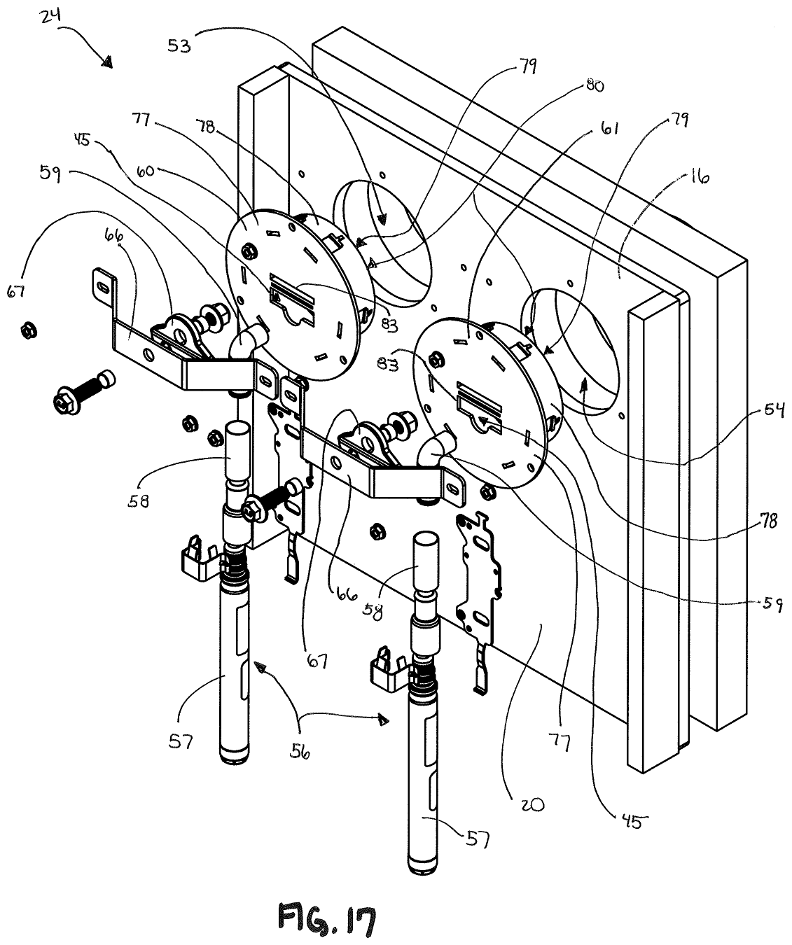

The air bag housing units 60 and 61 are configured to engage with the restraint harness 30 of the modular seat assembly 10 to permit the restraint harness 30 to extend from behind the seat back 16 to the front of the seat back 16 in order to secure the occupant seated in the assembly 10. Illustratively, and as shown in FIGS. 2 and 16, the back wall 77 of the housing unit 60 is also formed with a web receiver 82. The web receiver 82 includes a web aperture 83 that permits the first shoulder web 27 to extend from behind the seat back 16, through the housing unit 60, through the web aperture 72 of the air bag 62, and out through the bag outlet 80 to extend along the front surface 23 of the seat back 16 to be usable by the occupant. The web receiver 82 may be integral to the back wall 77 or a separate component. A similar configuration may be provided for the second shoulder web 29 to extend through the housing unit 61.

The pre-tensioning system 40 of the present disclosure will now be described. In various embodiments, the pre-tensioning system 40 includes one or more impact or rollover sensor systems, and one or more web tensioning assemblies for the lap webs 31 and 33, respectively, of the restraint harness 30. As illustrated in FIGS. 2 and 9, the pre-tensioning system 40 may include a first web tensioning assembly 42 associated with the first lap web 31, and a second web tensioning assembly 44 associated with the second lap web 33. However, other embodiments and configurations are envisioned herein. For instance, a single sensor system may operate multiple web tensioning assemblies. Alternatively still, the sensor system for the pre-tensioning system 40 may be the same sensor system electronically connected to the inflator system 56 of the airbag deployment system 24, described above. A single web tensioning assembly may further be associated with multiple webs (e.g. lap and/or shoulder) of the restraint harness 30.

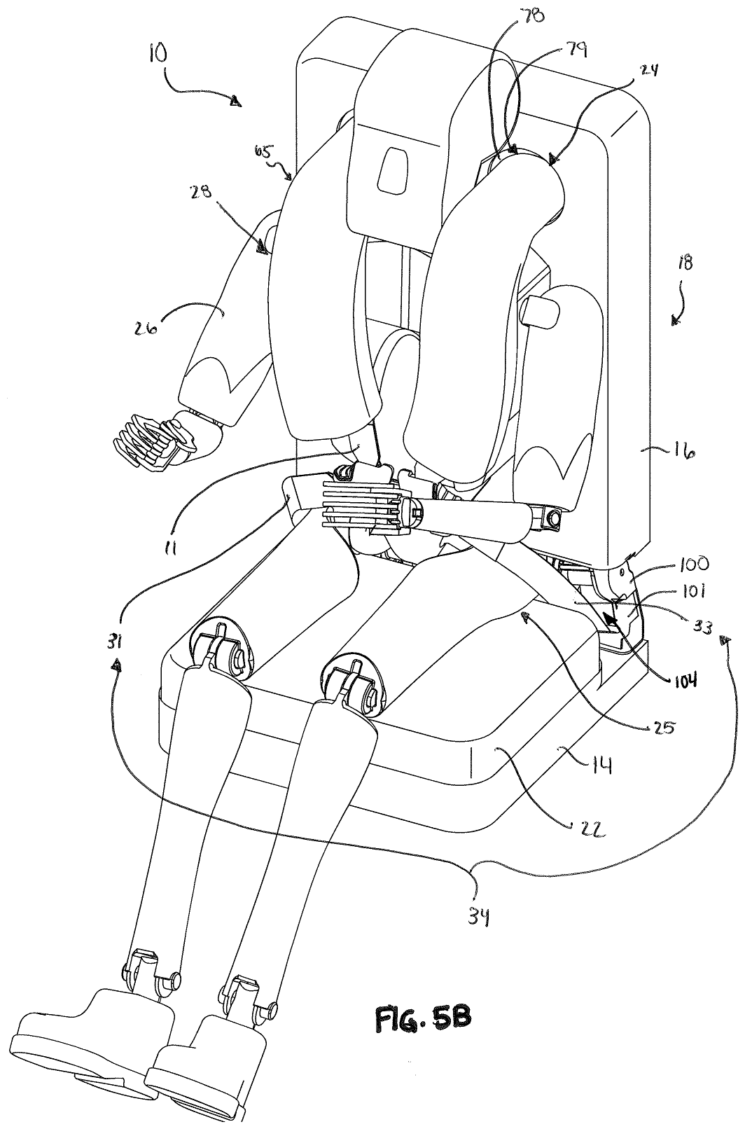

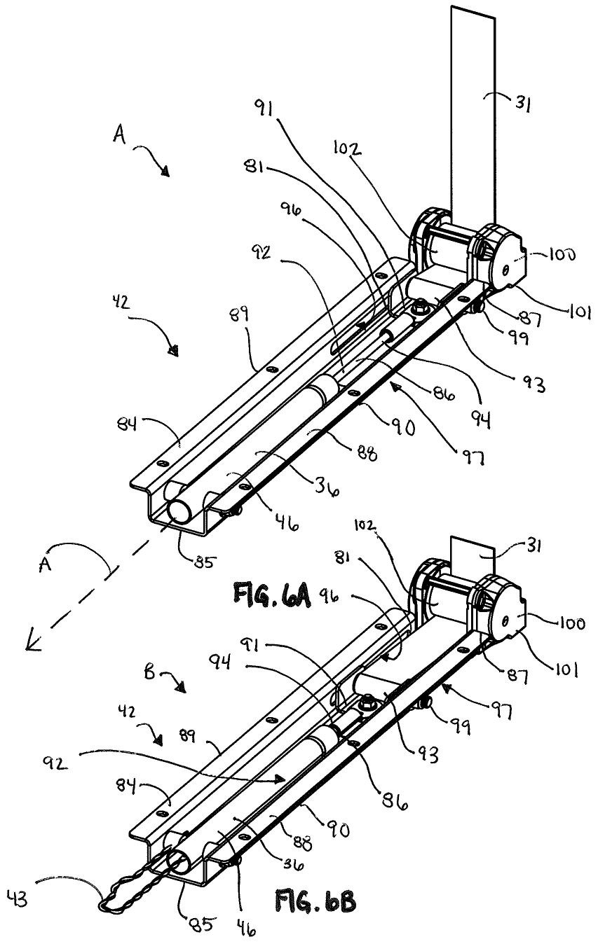

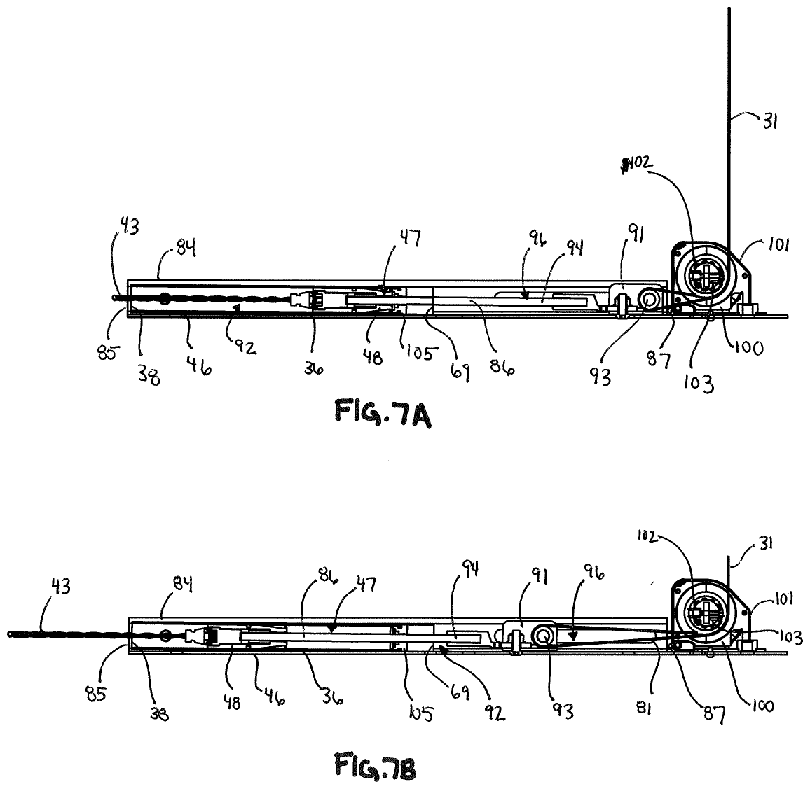

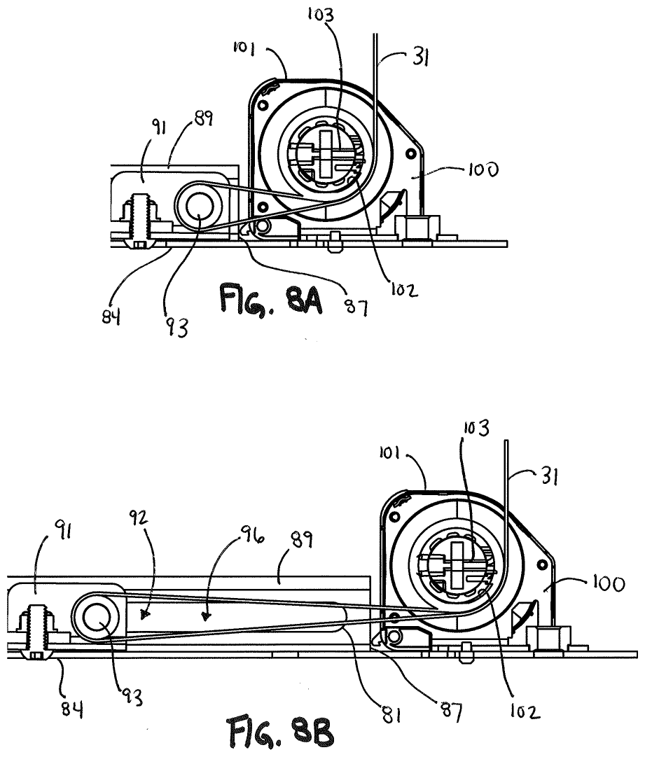

Illustratively, the first web tensioning assembly 42 can be seen in FIGS. 6A-8B. This disclosure will describe the first web tensioning assembly 42 in detail, but the second web tensioning assembly 44 may illustratively be similar in operation and components as the first web tensioning assembly 42. As illustrated, the first web tensioning assembly 42 includes an assembly housing 84, a slidable web tensioning bar 86 configured to retain a portion of the restraint harness 30 web, and an assembly actuator 36 configured to be electronically connected or controlled by the processor or sensor system. The actuator 36 is configured to be operated when there is detection of an impact or rollover event by the sensor system to cause a pre-tensioning of the restraint harness 30, particularly the first and second lap webs 31 and 33, to secure the restraint harness 30 around the occupant in the modular seat assembly 10. The actuator 36 is coupled to the slidable web tensioning bar 86 and configured to slide the tensioning bar within the housing 84 in order to tension the web of the restraint harness 30.

In various embodiments, the web tensioning assembly 42 is configured to be coupled or connected to a retractor assembly 100 that is similar to the retractor assembly 50 described above in order to receive a portion of the restraint harness 30, as illustrated in FIGS. 6A-8B. Illustratively, the retractor assembly 100 may be configured similar to known retractor assemblies in the industry that are configured to retract the lap webs 31 and 33 to a tensioned or specific-length state to retrain the web securing around an occupant. For instance, the web 31 may be received around a spool 102 mounted in a retractor frame 101 of the retractor assembly 100. The spool 102 is rotatably mounted to rotate within the frame 101 to permit winding or unwinding of the web 31 around the spool to lengthen or decrease the length of the web 31. The spool 102 may be biased with a biasing member 103 to rotate in a direction that causes the web 31 to be further rotated around (wound around) the spool, but the bias force can be overcome to unwind the web 31 from the spool by pulling on the web 31, as is known in the art. In various embodiments, the web 31 is configured to extend through an opening 104 between the seat back 16 and the seat bottom 14, through engagement with the tensioning assembly 42, and into the retractor assembly 100 that is positioned along the back of the seat back 16, as illustrated in FIG. 2. Accordingly, decreasing the length and/or tensioning the web 31 by either the web tensioning assembly 42 and/or the retractor assembly 100 causes a person contained between the web 31 and the seat back 16 to be more securely held in place in the event of an impact or crash event.

The assembly housing 84 of the tensioning assembly 42 includes a first end 85, a second end 87, and a body 88 extending between the first end 85 and the second end 87. The body 88 may be U-shaped in form with a first side 89 and a second side 90 spaced apart from and generally parallel to the first side 89, the body 88 formed to include a passageway 92 defined between the first and second sides 89 and 90 and generally extending between the first end 85 and second end 87. The first side 89 is formed to include a first slot 96 extending near the second end 87 of the housing 84, and the second side 90 is formed to include a second slot 97 extending near the second end 87 of the housing 84, with the first and second slots 96 and 97 being generally parallel and aligned with each other. The first slot 96 includes a first end 81 and the second slot 97 includes a second end 106, each of which are generally positioned adjacent the second end 87 of the assembly housing 84. The passageway 92 is configured to receive the assembly actuator 36 and the tensioning bar 86 and sized to permit the bar 86 to slide along a slide axis A through engagement with the slots 96 and 97. The slide axis A is generally aligned with the housing 84, and is further generally aligned with the cross-sectional line A-A as illustrated in FIGS. 11-12. The slots 96 and 97 generally extend parallel to the axis A in illustrative embodiments. When the assembly housing 84 is coupled to the back surface of the seat back 16, the second end 87 is positioned closer to the seat bottom 14 (closer to the floor of the vehicle) and the first end 85 is positioned adjacent the top of the seat back 16 (near the airbag deployment system 24).

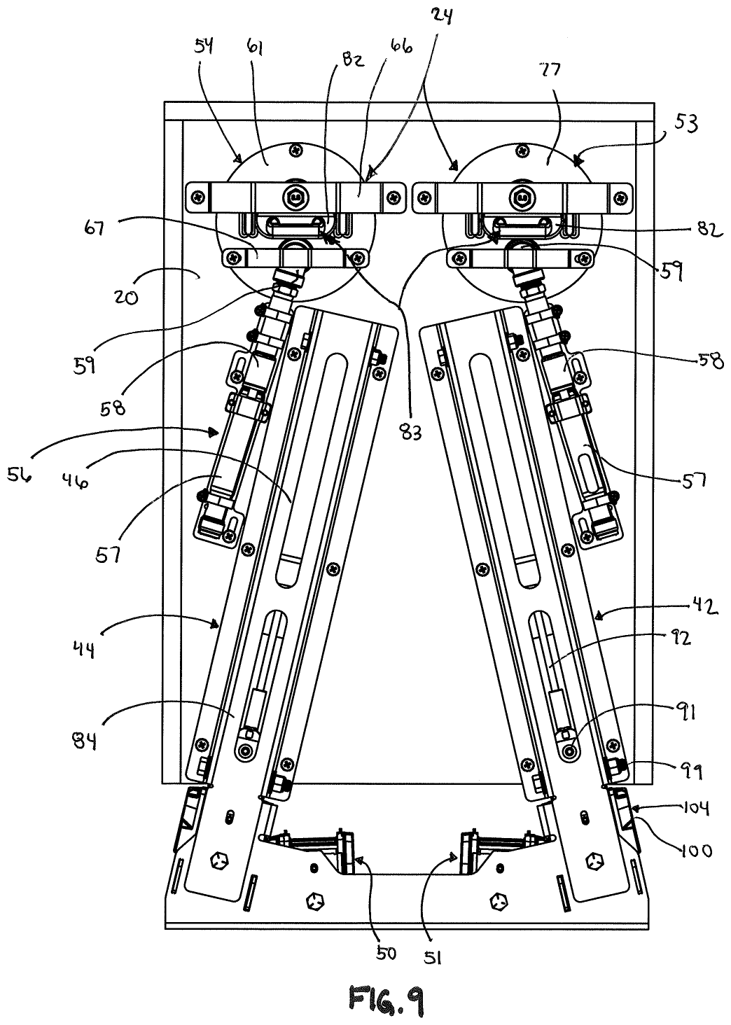

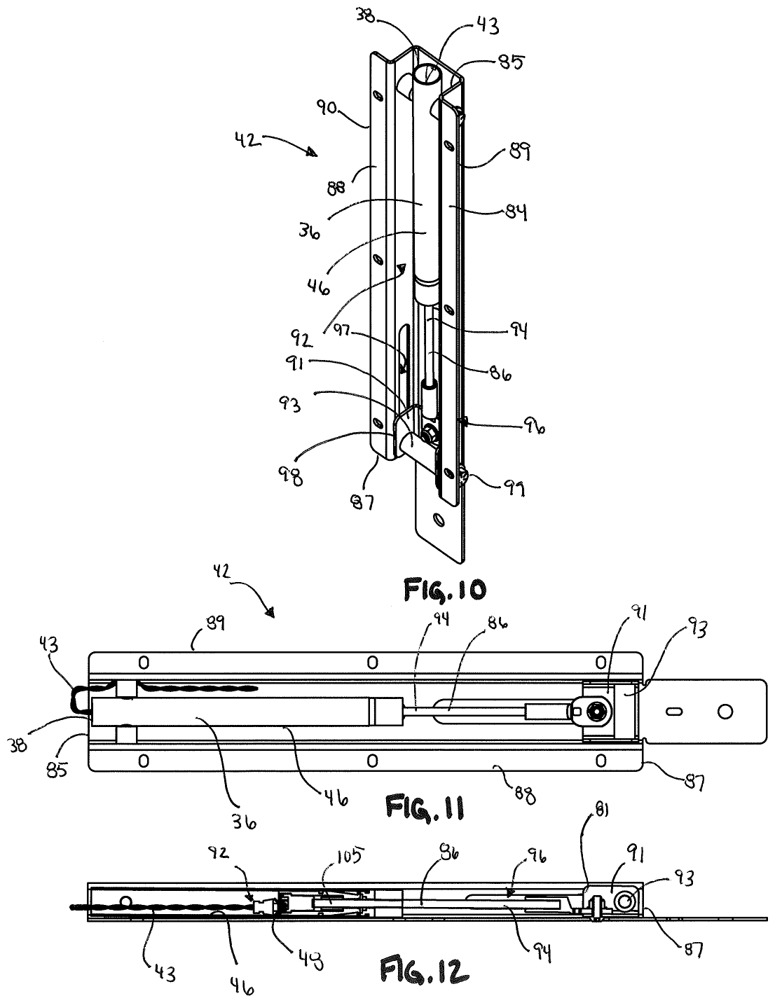

As illustrated in FIGS. 6A-8B, the tensioning bar 86 includes a web-receiving housing 91, a web spool 93 that is retained within the web-receiving housing 91, and an attachment arm 94 that is coupled to the web-receiving housing 91. In illustrative embodiments, the web-receiving housing 91 may include a first pin that engages with the first slot 96 in the assembly housing 84, and a second pin that engages with the second slot 97 in the assembly housing 84, in order to slideably retain the web-receiving housing 91 within the assembly housing 84. Accordingly, the slots 96 and 97 act as a track for the web-receiving housing 91 to slide along when moving within the assembly housing 84. In another illustrative embodiment as shown in FIGS. 6A-6B and 9-10, fasteners 99 (e.g. bolts) configured to retain the web spool 93 within the web-receiving housing 91 may act similar to such pins. Specifically, such fasteners 99 may be configured with a diameter that is larger than the width of the slots 96 and 97 and may be fastened onto the web spool 93 (e.g. onto a screw or other similar fastener receiver that is fixed to the spool 93) when the slots 96 and 97 are positioned between the fasteners 99 and spool 93. Accordingly, such fasteners 99 may retain the web-receiving housing 91 and web spool 93 in a slideable, but otherwise secured configuration with respect to the assembly housing 84, as understood by someone of skill in the art.

Illustratively, a portion of the lap web 31 that extends from the retractor assembly 100 is configured to be wound around the web spool 93 and to double back towards or through the retractor assembly 100 and then extending out of the opening 104 adjacent the seat back 16 in order to be attached to the female or male buckle member 13 or 15. In such an embodiment, the length of the lap web 31 that extends between the spool 102 of the retractor assembly 100 and the opening 104 is approximately double a length L (e.g. 2L) between the web spool 93 and the opening 104, as illustrated in FIG. 7A-7B. Similarly, movement of the tensioning bar 86 a distance D will generally cause a length of 2D of the web 31 to be pulled into the assembly housing 84 from the opening 104 adjacent the seat back 16, thereby tightening the web 31 around the occupant to brace for an impact event. When the web 31 is wrapped around the web spool 93, it encompasses a little more than half of the perimeter of the web spool 93. A portion of the attachment arm 94 is configured to be retained by the actuator 36 and to be moveable with the actuator 36 when the actuator is activated to tension the web 31 around an occupant.

As is understood by one of skill, the tensioning bar 86, and particularly the web-receiving housing 91, will naturally slide within the slots 96 and 97 of the assembly housing 84 to the lowest point (the point closest to the floor) due to gravitational forces. As illustrated in FIG. 9, the lowest point will generally correspond with the first end 81 of slot 96 and the first end 98 of slot 97, both of which are the closer end of the slots to the second end 87 of the assembly housing 84. This is generally a pre-deployment position A of the tensioning bar 86. As illustrated in FIGS. 6A-6B, the tensioning bar 86 is configured to move from the pre-deployment position A to a post-deployment position B when the actuator 36 is activated and moves the attachment arm 94 of the tensioning bar 86 toward the first end 85 of the assembly housing 84. Such movement of the attachment arm 94 involves enough force to overcome the gravitational pull on the tensioning bar 86, and therefore the web-receiving housing 91 will slide upward toward the first end 85 of the assembly housing 84 within the slots 96 and 97, sliding away from first ends 81 and 98 of the slots 96 and 97. This upward movement causes the web 31 extending around the web spool 93 to be pulled further into the assembly housing 84, thereby pulling more web 31 from the seating area 25 and tightening the web 31 around the occupant.

In illustrative embodiments, it is envisioned within the scope of this disclosure that the actuator 36 may be configured in a variety of manners. For instance, the actuator 36 may be housed within an actuation tube 46 received within the passageway 92 of the assembly housing 84, the actuation tube 46 having a first end 38 and a second end 69. The actuation tube 46 may be hollow and be secured to a portion of the assembly housing 84 to prevent movement of the tube 46. The actuator 36 may further include a base portion 105 that is fixedly secured to the second end 69 of the tube 46 and an inflator piston 48 moveably received within a cavity 47 of the tube 46. The inflator piston 48 is configured to be moveable toward and away from the base portion 105, and the inflator piston 48 is slideable within the tube 46. The attachment arm 94 of the tensioning bar 86 may be fixed to the inflator piston 48 to slide therewith, and may further extend through an aperture of the base portion 105 (thereby sliding within the base portion 105) and out into the passageway 92 of the assembly housing 84 in order to be attached to the web-receiving housing 91.

As discussed, the actuator 36 is configured to be responsive to one or more electrical signals received via an electrical wire 43 coupled to the sensor system. The actuator 36 may be illustratively configured to actuate the inflator piston 48 to release pressurized gas contained therein into the cavity 47. The release of pressurized gas into the container will cause the cavity 47 to expand, thereby sliding the piston 48 away from the base portion 105. Specifically, when the sensor system determines, for example, from the inertia, speed, and/or acceleration of the vehicle, that an impact or rollover event is imminent, an electrical signal will be sent through the electrical wire 43 to actuate the actuator 36, the inflator piston 48 will release the pressurized gas into the cavity 47. As the inflator piston 48 slides away from the base portion 105, it carries the attachment arm 94 of the tensioning bar 86, thereby sliding the tensioning bar 86 closer to the first end 38 of the actuation tube 46 and the first end 85 of the assembly housing 84. This in turn will cause the tensioning bar 86 to pull more web 31 into the assembly housing 84, thereby tightening or tensioning the web 31 around the occupant.

Other means for forming the actuator 36 are envisioned herein. The actuator may be deployment by any means that causes the attachment arm 94 of the tensioning bar 86 to slide within the assembly housing 84 along the axis A, thereby pulling the web 31 further into the housing 84.

The pre-tensioning system 40 is illustratively configured to be fully secured to the seat frame 18 of the modular seat assembly 10 in order to be movable and installable into the vehicle therewith. Similarly, as described above, the airbag deployment system 24 is also secured within and/or to the seat frame 18 to be movable and installable into the vehicle with the seat assembly 10. In such a manner, the safety features of the airbag deployment system 24 and pre-tensioning system 40 are integrated into the seat assembly 10 and can be installed into a vehicle by installing the seat assembly 10 in the vehicle. Such safety systems can accordingly be incorporated into a variety of vehicles or other similar machinery without special need to integrate or attach such features into the vehicle (e.g. frame) itself.

In various embodiments, both the airbag deployment system 24 and the pre-tensioning system 40 may be simultaneously or near simultaneously operated upon detection of an impact or crash event by the sensor system. In alternative embodiments, it may be desirable to activate the pre-tensioning system 40 slightly before (e.g. a second or less before) activation of the airbag deployment system 24. Such order of operations would permit the pre-tensioning system 40 to tension or tighten the restraint harness 30 around the occupant to secure/hold the occupant in a relatively fixed position against the seat back 16 and seat bottom 14 before the airbag deploys around the occupant's shoulders and torso, thereby reducing the risk of the airbag deployment causing injury to the occupant or pushing the occupant in an undesired position away from the seat back 16 and seat bottom 14 before the impact event occurs. Depending on the situation and the predicted impact that may occur, however, other orders of operation are envisioned herein.

While the disclosure has been illustrated and described in detail in the drawings and foregoing description, such an illustration and description is to be considered as exemplary and not restrictive in character, it being understood that only illustrative embodiments have been shown and described and that all changes and modifications consistent with the disclosure and recited claims are desired to be protected.

What is claimed is:

1. A modular vehicle seat assembly comprising:
a seat bottom;
a seat back coupled to the seat bottom, the seat back including a front surface and a back surface, the seat bottom and seat back forming a seating area for an occupant;
a restraint system coupled to the back surface of the seat back and configured to include a first shoulder web that extends through an opening in the seat back and configured to extend around a portion of the occupant seated in the seat assembly; and
an airbag deployment system configured to change between an undeployed state to a deployed state in the event of an impact force upon the vehicle, the airbag deployment system comprising:
a housing unit received within the opening in the seat back, the housings unit including a back wall, an airbag storage region and formed to include an outlet opposite of the back wall, the back wall being substantially aligned with the back surface of the seat back and secured thereto;
an airbag that coaxially surrounds the first shoulder web when the airbag is deployed, the airbag receivable within the airbag storage region of the housing unit, the airbag including a first end having a valve and an attachment strap configured to attach the airbag to the housing unit, and the airbag having a second end that is not connected to the housing unit and extends out of the outlet of the housing unit when the airbag is inflated; and
an inflator coupled to the back surface of the seat back, the inflator including an outlet port adjacent the back wall of the housing unit and is connected to the valve of the airbag to inflate the airbag.

2. The modular vehicle seat assembly of claim 1, wherein the housing unit further includes a front wall that is spaced apart from the back wall and extends across the outlet of the housing unit.

3. The modular vehicle seat assembly of claim 2, wherein the front wall includes a web passage for a portion of the first shoulder web to extend therethrough.

4. The modular vehicle seat assembly of claim 1, wherein the restraint system further includes a second shoulder web that extends through an opening in the seat back and is configured to extend around a portion of the occupant, and wherein the airbag deployment system further includes a second housing unit received within the opening in the seat back and a second airbag that coaxially surrounds the second shoulder web.

5. The modular vehicle seat assembly of claim 4, wherein a second inflator is coupled to the back surface of the seat back and includes a second outlet port connected to a second valve in the second airbag to inflate the second airbag.

6. The modular vehicle seat assembly of claim 4, wherein the first and second housing units include first and second front walls extending across the outlets of the first and second housing units.

7. The modular vehicle seat assembly of claim 1, wherein the restraint system further comprises a lap web configured to be secured around the occupant and a retractor assembly configured to retract the lap web away from the seating area when the lap web is not in use by the occupant.

8. The modular vehicle seat assembly of claim 7, wherein the assembly further includes a pre-tensioning system configured to pre-tension the lap web of the restraint system upon detection of the impact force event.

9. The modular vehicle seat assembly of claim 8, wherein the pre-tensioning system includes a housing coupled to the back surface of the seat back, a web tensioning bar configured to retain a portion of the lap web within the housing, and an actuator that can slide the web tensioning bar within the housing from a first position to a second position.

10. The modular vehicle seat assembly of claim 9, wherein the lap web extends from the retractor assembly, through a web spool in the web tensioning bar, and then into the seating area, and wherein sliding of the web tensioning bar from the first position to the second position causes a portion of the lap web to be pulled from the seating area into the housing, thereby tightening the lap web around the occupant.

11. The modular vehicle seat assembly of claim 8, wherein the pre-tensioning system is activated to pre-tension the lap web prior to deployment of the airbag of the airbag deployment system.

12. The modular vehicle seat assembly of claim 11, wherein the pre-tensioning device is activated less than a second before the airbag is deployed.

13. The modular vehicle seat assembly of claim 9, wherein the actuator of the pre-tensioning system is activated by a sensor system, the sensor system including a sensor configured to produce one of a roll signal and an impact signal, a processor, and a memory unit.

14. The modular vehicle seat assembly of claim 13, wherein the memory includes instructions stored therein which, when executed by the processor, cause the processor to process the one of the roll signal and the impact signal and to produce an activation signal if the roll signal indicates an imminent roll condition of a motor vehicle in which the vehicle seat is mounted and the impact signal indicates an imminent impact of the motor vehicle.

15. A restraint system for vehicle seat assembly, the system comprising:
a restraint harness including a first shoulder portion and a second shoulder portion;
an airbag deployment system configured to change between an undeployed state to a deployed state in the event of an impact force upon the seat assembly, the airbag deployment system comprising:
a first housing unit including a first back wall, a first airbag storage region and formed to include a first outlet opposite of the first back wall, a portion of the first shoulder portion of the restraint harness extending through the first back wall;
a first airbag that coaxially surrounds the first shoulder portion when the first airbag is deployed, the first airbag receivable within the first airbag storage region of the first housing unit, the first airbag including a first end having a first valve, and the first airbag having a second end that is not connected to the first housing unit and extends out of the first outlet of the first housing unit when the first airbag is inflated;
a second housing unit including a second back wall, a second airbag storage region and formed to include a second outlet opposite of the second back wall, a portion of the second shoulder portion of the restraint harness extending through the second back wall;
a second airbag that coaxially surrounds the second shoulder portion when the second airbag is deployed, the second airbag receivable within the second airbag storage region of the second housing unit, the second airbag including a first end having a second valve, and the second airbag having a second end that extends out of the second outlet of the second housing unit when the second airbag is inflated; and
at least one inflator including at least one outlet port connected to the first and second valves of the first and second airbags to inflate the airbags.

16. The restraint system of claim 15, wherein the first and second airbags are inflated at the same time after occurrence of an impact force.

17. A restraint system for vehicle seat assembly, the system comprising:
a restraint harness including a lap web portion;
a retractor assembly configured to retract the lap web portion within a retractor housing;
a sensor system configured to detect an impending or occurring impact or rollover event for the vehicle; and
a pre-tensioning system engageable with the lap web portion, the pre-tensioning system including a housing, a web tensioning bar slidable within the housing and an actuator, the actuator in communication with the sensor system and configured to move the web tensioning bar from a first position to a second position within the housing when the sensor system indicates detection of an impact or rollover event;
wherein the lap web portion extends from the retractor assembly, through the housing of the pre-tensioning system, and then into a seating area of the vehicle seat assembly.

18. The system of claim 17, wherein the web tensioning bar includes a web spool that the lap web portion extends around, the web tensioning bar configured to slide within a passageway of the housing from a first side of the housing to a second side of the housing.

19. The system of claim 18, wherein the web tensioning bar slides within a pair of slots extending within the first and second sides of the housing.

20. The system of claim 18, wherein the web tensioning bar includes a connector arm coupled to the actuator, the connector arm coupled to the web spool to move the web spool upon movement of the actuator.
